(19) United States
(12) Patent Application Publication
(10) Pub. No.: US 2011/0208558 A1
(43) Pub. Date: Aug. 25, 2011

(54) METHOD FOR SMOOTHING WORKLOAD AND SUPPORT SYSTEM FOR SMOOTHING WORKLOAD

(75) Inventor: Shuichi Wakita, Saitama (JP)

(73) Assignee: HONDA MOTOR CO., LTD., Tokyo (JP)

(21) Appl. No.: 13/127,601

(22) PCT Filed: Nov. 4, 2009
(86) PCT No.: PCT/JP2009/005847

§ 371 Date: May 4, 2011

(30) Foreign Application Priority Data
Nov. 5, 2008 (JP) 2008-284439
Nov. 5, 2008 (JP) 2008-284442

(51) Int. Cl. G06Q 10/00

(52) U.S. Cl. 705/7.15

(57) ABSTRACT

Creation of a bottle neck due to the presence of a worker under a particular heavy workload is fundamentally avoided, and the production efficiency of a work place where a plurality of workers jointly perform work is improved. The workload of each worker is numerically represented by using a worker load numerical processing unit (201), a workload deviation of each worker from a prescribed workload standard value is computed by using a workload deviation computing unit (203), and a work assistance device is allocated to each worker depending on the workload deviation of the worker by using a work assistance device allocation unit (204).

### TECHNICAL FIELD

The present invention relates to a method for smoothing workload and a support system for smoothing workload, and in particular to a method for smoothing workload and a support system for smoothing workload that are adapted to smooth the workload among a plurality of workers working in a factory or other working environment.

### BACKGROUND OF THE INVENTION

For the purpose of improving the productivity in an assembly line of a manufacturing plant, it has been proposed to design each zone of the assembly plant based on the man-hours required for the particular zone and to provide a support for allocating various work steps to different work stations with the aid of an information processing system such as a computer (see JP 2002-79964A and JP 2003-15723).

A support technology for work planning that allows the workload of each individual worker to be adjusted so as to be even or smooth has been proposed in JP 7-43261A, for instance, by measuring the maximum muscle load of each worker in performing each particular kind of work for a certain period of time in an assembly line of a plant, and computing an index (workload evaluation index) that allows the workload born by the particular worker to be objectively evaluated.

### BRIEF SUMMARY OF THE INVENTION

### Task to be Achieved by the Invention

In a work environment such as an assembly line where a plurality of workers perform a certain sequence of work, the physical workload for each worker inevitably differs from that of the other worker because of the variations in the contents of the work and competence of each worker. Therefore, if there is any worker in the given assembly line who is subjected to a heavier workload than others, this may cause a bottleneck that increases the takt time (cycle time) and lowers the production efficiency of the entire assembly line.

Previous proposals were directed to the technology of designing the assembly line and improving the productivity, and did not provide a solution to the problem of the reduction in the production efficiency of an assembly line due to the presence of a bottleneck caused by a worker subjected to a particularly heavy workload.

In view of such problems of the prior art, a primary object of the present invention is to fundamentally correct the situation where the production efficiency of an assembly line is lowered due to the presence of a bottleneck caused by a worker subjected to a particularly heavy workload, and to improve the production efficiency of a work environment where a plurality of worker performs work.

### Means to Achieve the Task

The present invention provides a method for smoothing workload by using an information processing system in a work place where a plurality of workers jointly perform work, comprising the steps of: numerically representing workload of each worker according to information correlated with the workload of the worker; determining a prescribed standard workload value; computing a workload deviation of each worker from the standard workload value determined in the step of determining a prescribed standard workload value; and allocating a work assistance device to each worker depending on the workload deviation computed in the step of determining a workload deviation.

In the method for smoothing workload of the present invention, preferably, the step of allocating a work assistance device comprises allocating a work assistance device to a worker whose workload is substantially greater than the standard workload value, and the method further comprises the step of setting an amount of work assistance provided by the work assistance device to a level that brings the workload deviation close to zero.

In the method for smoothing workload of the present invention, preferably, the information correlated with the workload of the worker includes at least a physiological value of the worker measured by a physiological sensor worn by the worker, an amount of work assistance provided by the work assistance device worn by the worker or a joint moment value estimated from a floor reaction force detected by a floor reaction force sensor worn by the worker.

In the method for smoothing workload of the present invention, preferably, the work assistance device comprises a walking assistance device that is configured to be worn by the worker to induce the step ratio of the worker to a target step ratio, and the method further comprises the step of setting a step ratio that minimizes energy consumption of the worker at a current walking speed as the target step ratio by referring to a property data defining a correlation between the walking speed and the worker's energy consumption.

In the method for smoothing workload of the present invention, preferably, the method further comprises the step of acquiring information on the workload and position of each worker from the work assistance device, and visually displaying a distribution of workload among the workers of the work place on a monitor according to the acquired information on the workload and position of each worker.

The present invention also provides a support system for smoothing workload in a work place where a plurality of workers jointly perform work, comprising: a worker load numerical processing unit configured to numerically represent workload of each worker according to information correlated with the workload of the worker; a workload standard value determining unit configured to determine a prescribed standard workload value; a workload deviation computing unit configured to compute a workload deviation of each worker from the standard workload value; and a work assistance device allocation unit configured to allocate a work assistance device to each worker depending on the workload deviation computed by the workload deviation computing unit.

In the support system for smoothing workload of the present invention, preferably, the work assistance device allocation unit is configured to allocate a work assistance device to a worker whose workload is substantially greater than the standard workload value, and the support system further comprises a work assistance quantity determining unit that sets the amount of work assistance provided by the work assistance device such that the workload deviation is close to zero.

In the support system for smoothing workload of the present invention, preferably, the work assistance device comprises a walking assistance device that is configured to be worn by the worker to induce the step ratio of the worker to a target step ratio, and the support system further comprises a target step ratio setting unit configured to set a step ratio that minimizes energy consumption of the worker at a current walking speed as the target step ratio by referring to a property data defining a correlation between the walking speed and the worker's energy consumption.

### Effect of the Invention

According to the method for smoothing workload and the support system for smoothing workload, the workload of each worker is represented by a workload value or quantitized so that the a work assistance device may be allocated to each worker depending on the worker's workload in relations with the workload standard value.

Thereby, the worker bearing a heavy workload, and causing a bottle neck is allocated with a work assistance device so that the workload of the worker under a heavy workload is relieved of some of the workload, and the workload can be made even or smooth among the entire workers. As a result, the production efficiency can be improved in the work place where a plurality of workers jointly perform work.

### BRIEF DESCRIPTION OF THE DRAWINGS

FIG. 1 is a perspective view of an embodiment of the walking assistance device that may be used for the method for smoothing workload according to the present invention;

FIG. 2 is an exploded perspective view of the walking assistance device that may be used for the method for smoothing workload according to the present invention;

FIG. 3 is a simplified perspective view of an embodiment of the loading work assistance device that may be used for the method for smoothing workload according to the present invention;

FIG. 4 is a simplified side view of the loading work assistance device that may be used for the method for smoothing workload according to the present invention;

FIG. 5 is a simplified front view of the loading work assistance device that may be used for the method for smoothing workload according to the present invention;

FIG. 6 is a block diagram of an embodiment of the workload smoothing support system according to the present invention;

FIG. 7 is a diagram illustrating the concept of the inverse dynamics model;

FIG. 8 is a diagram showing the joint reaction forces and join torques acting on an i-th link;

FIG. 9 is a diagram showing the geometrical relationship between the walking assistance device and the worker wearing the device;

FIG. 10 is a graph showing the relationship between the joint bending angle of the device and the joint bending angle of the worker;

FIGS. 11(a) to 11(c) show the workload values and work assistance quantities of different workers in relation with the workload standard value;

FIG. 12 is a flowchart showing the control flow of the embodiment of the workload smoothing support system;

FIG. 13 is a block diagram of another embodiment of the workload smoothing support system;

FIG. 14 is a graph showing the relationship between the step ratio and energy consumption;

FIG. 15 is a flowchart showing the control flow of the other embodiment of the workload smoothing support system;

FIG. 16 is a diagram showing an automotive assembly line to which the embodiment of the method for smoothing workload is applied;

FIG. 17 is a diagram showing the allocation of work assistance devices in the automotive assembly line to which the embodiment of the method for smoothing workload is applied;

FIG. 18 is a diagram showing the distribution of the workers and working condition in the automotive assembly line to which the embodiment of the method for smoothing workload is applied;

FIG. 19 is a table showing the average energy consumption, average walking speed, average step ratio, worker IDs, average line speed and overall work load in the automotive assembly plant to which the embodiment of the method for smoothing workload is applied;

FIG. 20 is a diagram schematically illustrating the smoothing of the workload between different vehicle models and between different work steps in the automotive assembly plant to which the embodiment of the method for smoothing workload is applied;

FIG. 21 is a diagram schematically illustrating the smoothing of the workload among the workers in the entire assembly plant in the automotive assembly plant to which the embodiment of the method for smoothing workload is applied; and

FIG. 22 is a diagram showing the workload condition of a plant to which the embodiment of the method for smoothing workload is applied.

### DETAILED DESCRIPTION OF THE PREFERRED EMBODIMENT(S)

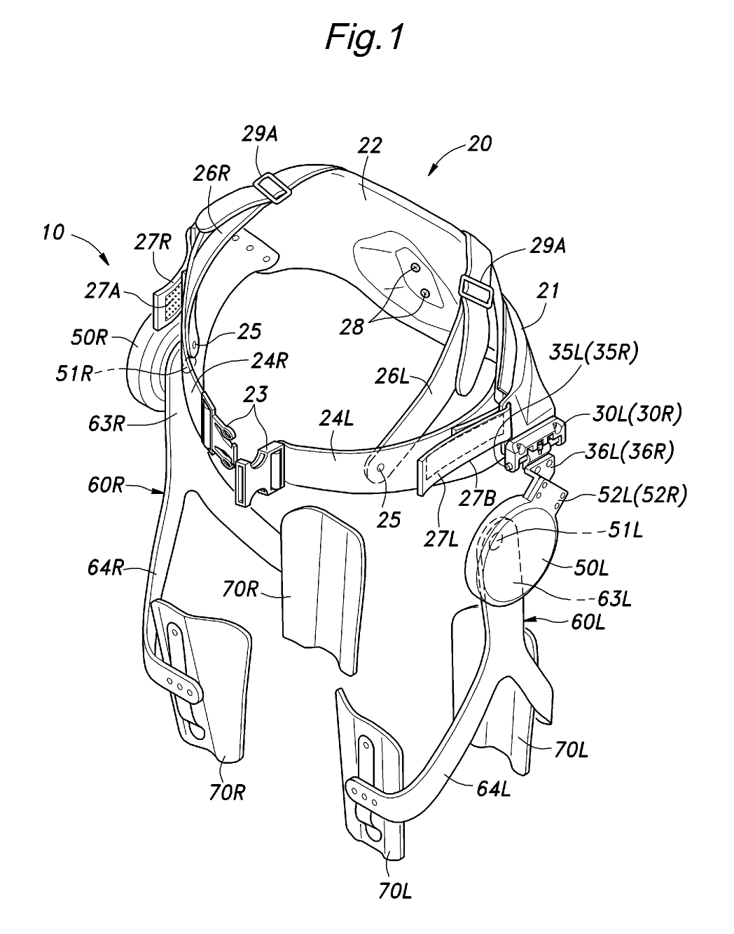

A preferred embodiment of the method for smoothing workload and the support device for smoothing workload embodying the present invention is described in the following with reference to FIGS. 1 to 8.

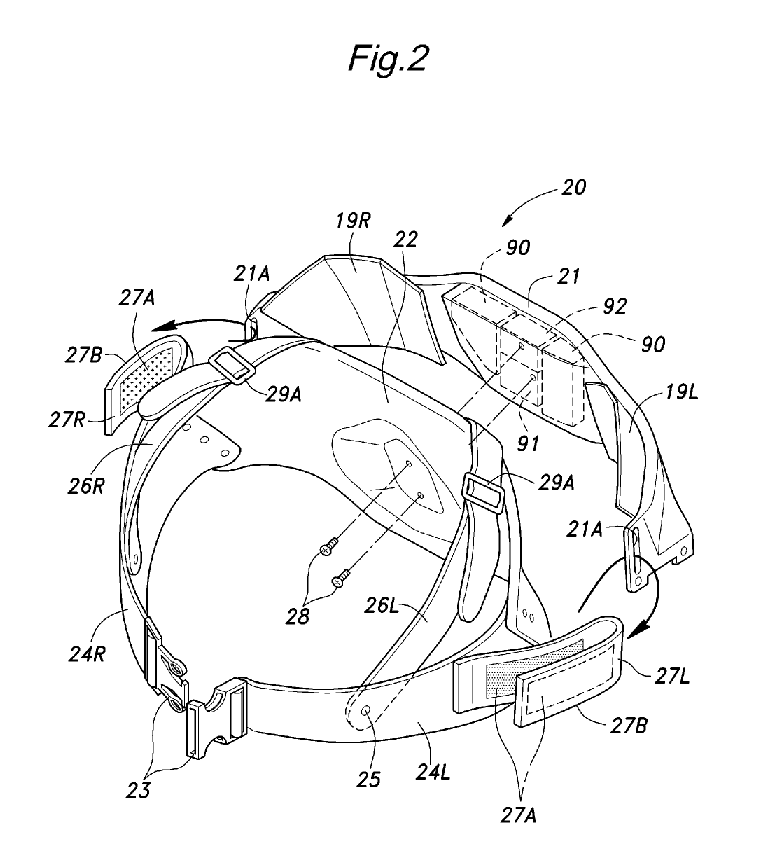

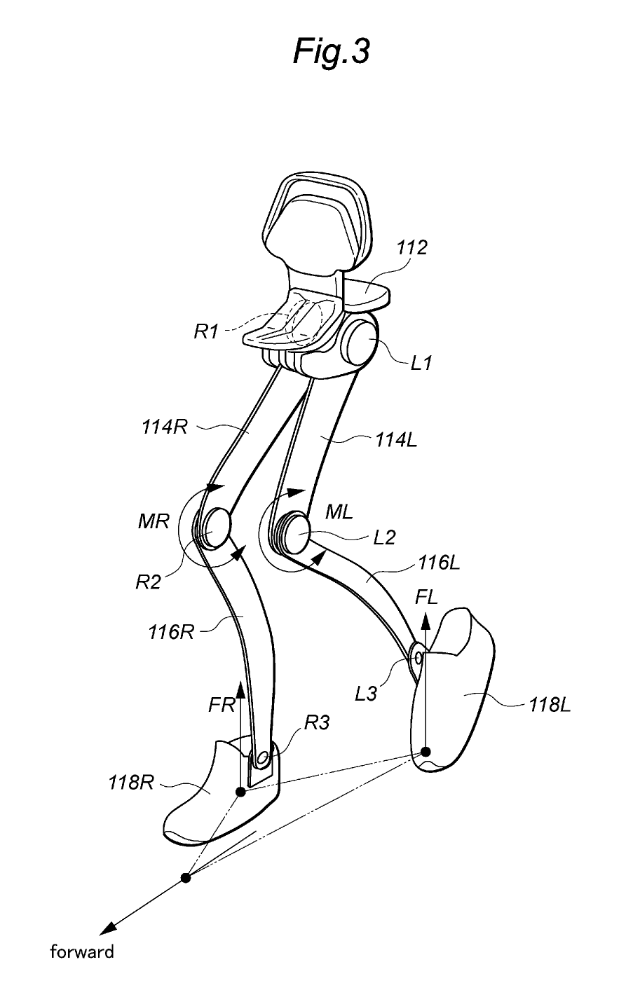

In the illustrated embodiment, a walking assistance device 10 for providing a walking assistance illustrated in FIGS. 1 and 2, and a loading work assistance device 100 for providing a loading work assistance illustrated in FIGS. 3 to 6 are prepared as the work assistance devices which each worker may select and use.

First of all, the walking assistance device 10 is described in the following with reference to FIGS. 1 and 2. Referring to FIG. 1, the walking assistance device 10 comprises a pelvic support member 20 configured to be worn on a pelvic part of the worker, a pair of electric motors 50L and 50R mounted on parts of the pelvic support member 20 corresponding to the hip joints of the worker, a pair of power transmitting arms 60L, 60R each having an upper end connected to an output member (output shaft) 51L, 51R of the corresponding electric motor 50L, 50R, and a pair of femoral support members 70L and 70R each attached to the lower end of the corresponding power transmitting arm 60L, 60R and worn by a corresponding femoral part of the worker.

Referring to FIG. 2, the pelvic support member 20 comprises a back frame 21, a back pad 22, a pair of abdominal belts 24L and 24R, a pair of auxiliary belts 26L and 26R and a pair of side belts 27L and 27R.

The back frame 21 consists of a stiff member made of metallic material, for instance, and surrounds the pelvic back part of the worker in a spaced relationship. The back frame 21 is incorporated with a control unit 90 for controlling the action of the electric motors 50L and 50R, a power source unit 91 and a wireless communication unit 92. The wireless communication unit 92 performs a bi-directional data communication with a floor mounted workload reduction support processing unit (workload smoothing support unit) 200, which will be described hereinafter, according to a prescribed wireless communication protocol.

The back pad 22 is made of soft plastic material, and is fixedly secured to a laterally central part of the back frame 21 with screws 28. The lateral ends or free ends of the back pad 22 each extend to a point ahead of the corresponding front end of the back frame 21.

To each lateral side part of the back frame 21 is fixedly attached an elastic plate 19L, 19R made of elastic material such as sheet spring, plastic plate and so on. Each elastic plate 19L, 19R is placed between the corresponding side part of the back pad 22 and the corresponding side part of the back frame 21 so as to resiliently urge the corresponding free end of the back pad 22 forward with respect to the back frame 21.

Each abdominal belt 24L, 24R is made of flexible material such as fabric, leather, PVC and so on, and has an end fixedly connected to the corresponding side end of the back pad 22 and another end releasably connected to the other abdominal belt via a snap-fit belt buckle 23.

Each auxiliary belt 26L, 26R is made of flexible material such as fabric, leather, PVC and so on, and has an end fixedly connected to a laterally middle part of the back side of the back pad 22 and another end pivotally connected to a middle part of the corresponding abdominal belt 24L, 24R via a pin 25. Each auxiliary belt 26L, 26R is fitted with an adjustment buckle 29A so that the length of the auxiliary belt 26L, 26R may be adjusted.

Each side belt 27L, 27R is also made of flexible material such as fabric, leather, PVC and so on, and has an end fixedly connected to a point of the corresponding abdominal belt 24L, 24R intermediate between the pin 25 and the point of connection with the back pad 22, and another end fixedly connected to the corresponding lateral end of the back frame 21. The other end of each side belt 27L, 27R is connected to the back frame 21 in such a manner that the free end 27B of the side belt 27L, 27R is passed through a slot 21A formed in the back frame 21, and is releasably attached to the base end of the side belt 27L, 27R via a surface fastener 27A. Therefore, the length of each side belt 27L, 27R can be adjusted by changing the position of securing the free end 27B of the side belt 27L, 27R to the surface fastener 27A.

As shown in FIG. 1, each power transmitting arm 60L, 60R is adapted to transmit the output of the corresponding electric motor 50L, 50R to the corresponding femoral support members 70L, 70R. The lower end of each power transmitting arm 60L, 60R is bifurcated in the shape of an inverted letter-V, and is given with a spring property. The bifurcated ends of the power transmitting arm 60L, 60R oppose the femoral part of the worker from the front and back, respectively, and are each fitted with the corresponding femoral support member 70L, 70R fitted with a pad.

Each femoral support member 70L, 70R is detachably attached to the corresponding bifurcated lower end of the power transmitting arm 60L, 60R by using screws so that the femoral support member 70L, 70R may be vertically adjusted.

To each lateral end of the back frame 21 is fixed a hinge pin support member 30L, 30R. Each hinge pin support member 30L, 30R is provided with a pair of horizontal arms between which a hinge pin 35L, 35R is supported. Each hinge pin 35L, 35R has a central axial line extending in the fore-and-aft direction or in the sagittal direction of the worker.

Each hinge pin 35L, 35R supports a corresponding hinge connecting member 36L, 36R so as to be rotatable around the central axial line of the hinge pin 35L, 35R. To each hinge connecting member 36L, 36R is fixedly connected a mounting tab 52L, 52R integrally provided in the upper end of the corresponding electric motor 50L, 50R.

Each electric motor 50L, 50R receives the supply of electric power from the power source unit 91, and the control unit 90 individually controls the output torque and angular output of each electric motor 50L, 50R so that the two power transmitting arms 60L, 60R are actuated into a swinging movement that is consistent with the walking movement of the worker.

Thus, the output torques of the two electric motors 50L and 50R provide an appropriately timed walking assisting force to the femoral parts of the worker via the femoral support members 70L and 70R, and the walking movement of the worker is assisted in a pattern which is determined by the output torque and angular output of each electric motor 50L, 50R.

The loading work assistance device 100 is described in the following with reference to FIGS. 3 to 5. As shown in FIG. 3, the loading work assistance device 100 comprises a saddle 112 for the user to ride on, a pair of femoral link members 114L and 114R, a pair of crural link members 116L and 116R and shoes 118L and 118R configured to be worn by the feet of the user.

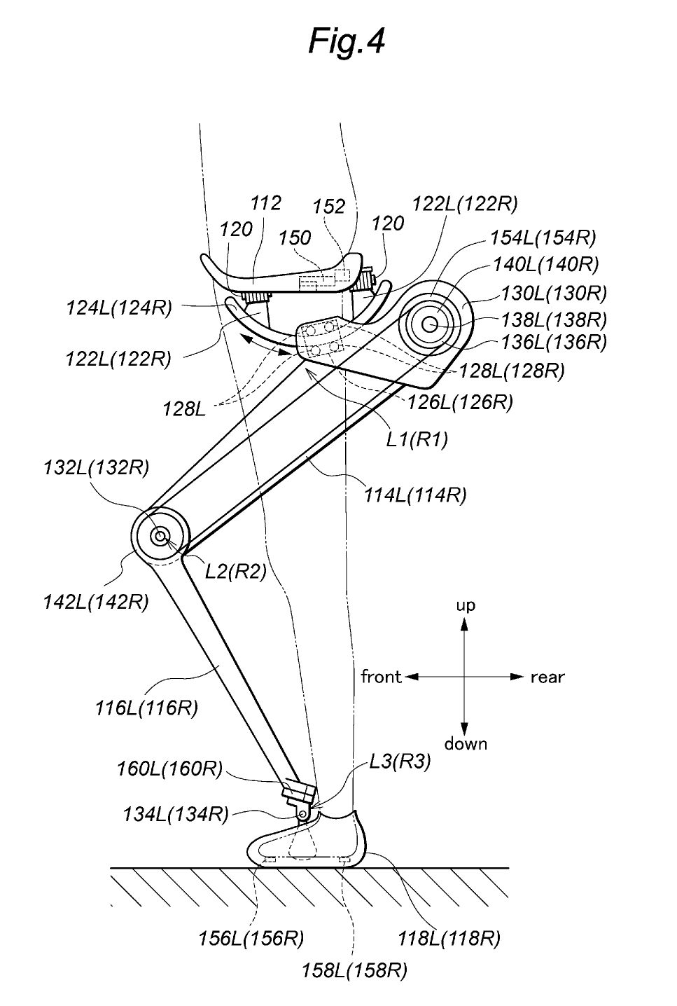

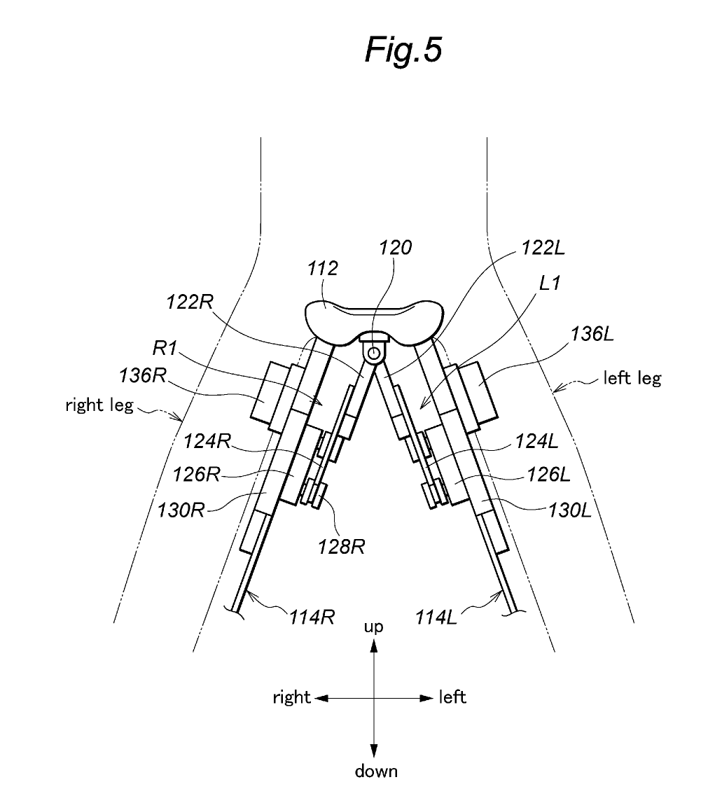

As shown in FIGS. 4 and 5, a lower middle part of the saddle 112 is provided with a hinge pin 120 extending in the fore and aft direction. To the hinge pin 120 is pivotally mounted a pair of arcuate guide bars 124L and 124R extending in the fore and aft direction so as to be enabled to swing laterally (leg opening movement) around the hinge pin 120. Each arcuate guide bar 124L, 124R slidably supports a slider 126L, 126R via guide rollers 128L, 128R. To each slider 126L, 126R is attached a base plate 130L, 130R which extends rearward beyond the point at which the base plate 130L, 130R is attached to the slider 126L, 126R. To the base plate 130L, 130R is fixedly connected the upper end of the corresponding femoral link member 114L, 114R.

The hinge pin 120, arcuate guide bars 124L and 124R, sliders 126L and 126R and base plates 130L and 130R are located so as to correspond to the right and left hip joints of the user, and these components are combined so that a pair of first joint mechanisms L1 and R1 configured to emulate the movement of the hip joints of the user are formed.

Each femoral link member 114L, 114R extends obliquely forward from a rear part of the corresponding base plate 130L, 130R. The free end (lower end) of each femoral link member 114L, 114R is pivotally connected to the upper end of the corresponding crural link member 116L, 116R via a substantially horizontal knee pivot pin 132L, 132R for a fore and aft swinging movement. The lower end of each crural link member 116L, 116R is pivotally connected to the corresponding shoe 118L, 118R via a substantially horizontal ankle pivot pin 134L, 134R for a fore and aft swinging movement.

Each knee pivot pin 132L, 132R is located so as to correspond to the corresponding knee joint, and forms a second joint mechanism L2, R2 that emulates the movement of the knee joint of the user. Each ankle pivot pin 134L, 134R is located so as to correspond to the corresponding knee joint, and forms a second joint mechanism L2, R2 that emulates the movement of the knee joint of the user.

Each base plate 130L, 130R is provided with an electric motor 136L, 136R having an output shaft 138L, 138R fitted with an output pulley 40L, 40R for delivering assisting power.

Each knee pivot pin 132L, 132R is fitted with a driven pulley 142L, 142R, and an endless belt 144L, 144R is passed around the output pulley 40L, 40R and driven pulley 142L, 142. By means of this power transmitting mechanism, the rotative power of each electric motor 136L, 136R is individually transmitted to the kneed pivot pin 132L, 132R that forms the second joint mechanism L2, R2. In other words, the power generated by each electric motor 136L, 136R is individually transmitted to the corresponding knee (knee joint) as assisting power.

The saddle 112 is incorporated with a battery power source (not shown in the drawings) for supplying electric power to the electric motors 136L and 136R, a control unit 150 for controlling the operation of the electric motors 136L and 136R and a wireless communication unit 152. The wireless communication unit 152 performs a bi-directional data communication with the floor mounted workload reduction support processing unit 200, which will be described hereinafter, according to a prescribed wireless communication protocol.

The system includes various sensors provided in various parts of the loading work assistance device 100 for detecting physical data such as rotary encoders 154L and 154R for detecting the rotational angles of the respective electric motors 136L and 136R, MP (metatarsophalangeal) sensors 156L and 156R for measuring the floor reaction forces of the left and right legs, respectively, heel sensors 158L and 158R and support force sensors 160L and 160R for measuring the support forces of the left and right legs, respectively.

Each MP sensor 156L, 156R consists of a multi-axial force sensor (at least two axes, vertical and horizontal), and is placed in the corresponding shoe 118L, 118R at a position corresponding to the metatarsophalangeal (MP) joint of the user wearing the shoe 118L, 118R to measure the floor reaction force.

Each heel sensor 158L, 158R consists of a multi-axial force sensor (at least two axes, vertical and horizontal), and is placed in the corresponding shoe 118L, 118R at a position corresponding to the heel of the user wearing the shoe 118L, 118R to measure the floor reaction force.

Each support force sensor 160L, 160R consists of a multi-axial force sensor (at least two axes, vertical and horizontal), and is mounted on the lower end of each crural link member 116L, 116R to measure the support force acting on the crural link member 116L, 116R. The support force measured by the support force sensor 160L, 160R is a physical quantity that is correlated to the floor reaction force.

The control unit 150 receives the signals from these sensors, signals representing the angular speeds of the chest and pelvis of the worker in the vertical direction, signals representing the accelerations of the chest and pelvis of the worker in the vertical and horizontal directions, and controls the output torques and rotational angles of the two electric motors 136L and 136R according to a prescribed control rule.

The electric motors 136L and 136R rotatively actuate the driven pulleys 142L and 142R by providing the output torques and rotational angles controlled by the control unit 150.

Thereby, the output torques of the electric motors 136L and 136R are applied to the knee joints of the worker as squat assist forces so that the workload of the worker performing work that requires squatting force is reduced according to the output torques and rotational angles delivered by the electric motors 136L and 136R.

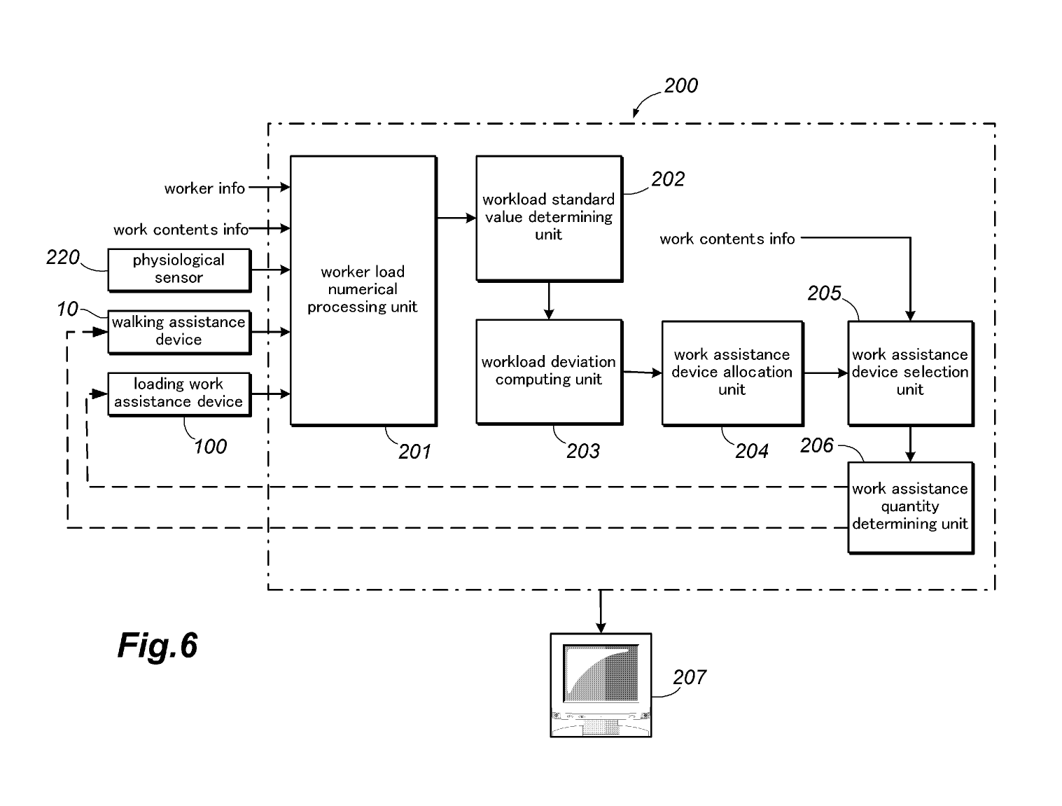

A workload smoothing support unit 200 embodying the present invention is described in the following with reference to FIG. 6. The workload smoothing support unit 200 in this embodiment consists of a floor mounted information processing system for smoothing the workload of workers in work places such as loading work places in factories, warehouses and wharves, construction work sites, parcels handling sites, farm and fishing products processing plants and so on. The following embodiment is applied to an automotive assembly plant, and is configured to support the smoothing of the workload primarily born by the lower limbs of the workers.

The workload smoothing support unit 200 includes a worker load numerical processing unit 201, a workload standard value determining unit 202, a workload deviation computing unit 203, a work assistance device allocation unit 204, a work assistance device selection unit 205 and a work assistance quantity determining unit 206. These individual units 201 to 206 of the workload smoothing support unit 200 are implemented by software or by a microcomputer operating under a computer program.

The workload smoothing support unit 200 is connected to an output device such as a display 207, and displays the various items of information generated by the individual units 201 to 206 on the display 207.

The worker load numerical processing unit 201 executes the process of numerically representing the workload of each worker in the automotive assembly line according to various items of information that are correlated with the workload on the particular worker, such as the worker information, work contents information, and physiological information such as the output signals of the electromyographic sensor, heart rate sensor, respiration sensor and perspiration sensor worn by the worker, and performing a prescribed algorithm for representing the workload of each worker by a numerical value according to the obtained information. The numerical value (workload value) representing the amount of workload of each worker can be given by energy consumption, caloric value or index, and so on. The energy consumption can be appropriately computed by using a formula Y=1.55e^{0.0203X}, where Y is the energy consumption (ml of O₂/Kg/min) and X is the heart rate.

The worker information may include the worker identification (such as the name and worker identification number of the worker), physical build, work competency and health condition of each worker. The work contents information is the information that identifies the contents of the particular work, and may include the lifting of objects, squatting and walking

Alternatively, the worker load numerical processing unit 201 may represent the workload of each worker according to the amount of work computed from the output values and power consumption of the walking assistance device 10 or loading work assisting device 100 which the worker is using.

The worker load numerical processing unit 201 may also represent the workload of each worker with numerical values by receiving the inputs of the signals from the MP sensors 156L and 156R and heel sensors 158L and 158R representing the floor reaction force or the detected value of the floor reaction force, estimating the joint moments of the user from the received detected values of the floor reaction force by using an inverse dynamics computational process, and referring to the estimated joint moments. The floor reaction force may also be computed from the measured values of the supporting forces of the right and left leg detected by the support force sensors 106L and 106R.

The floor reaction force used for computing the joint moments includes a left floor reaction force component FL (FLx, FLy) acting upon the left leg of the user and a right floor reaction force component FR (FRx, FRy) acting upon the right leg of the user. Here, FLx and FLy represent the components of FL acting in the horizontal and vertical directions, respectively. Likewise, FRx and FRy represent the components of FR acting in the horizontal and vertical directions, respectively.

The estimation of the joint moments can be performed by computing the right and left joint moments (joint torques) of the user from the floor reaction force FL (FLx, FLy) and FR (FRx, FRy) obtained from the measured values from the MP sensors 156L and 156R and heel sensors 158L and 158R or the measured values from the support force sensors 160L and 160R. This estimation computation may be based on the inverse dynamics computation.

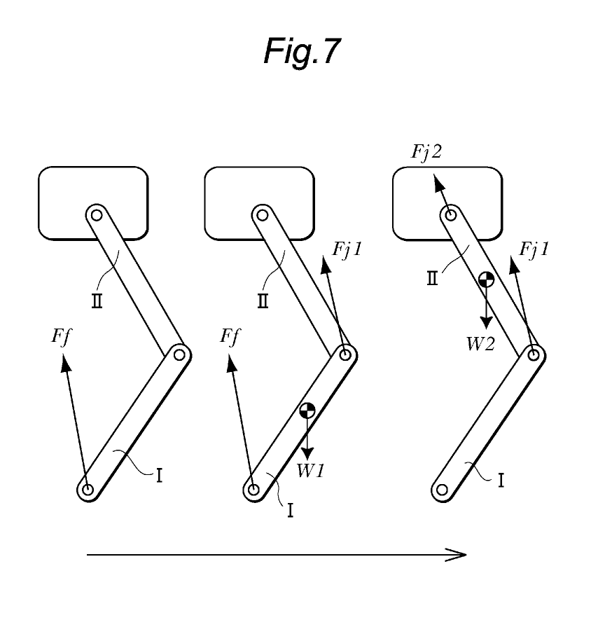

The computation of the joint moments based on the inverse dynamics computation is described in the following. First of all, the concept of the inverse dynamics model is described in the following with reference to FIG. 7. The inverse dynamics model allows internal forces to be estimated from the motion and boundary conditions, and, in this case, the inverse dynamics model is used for estimating the joint moments (torques) which are considered to be internal forces.

The reaction force Fj1 of the base end of the distal link I can be obtained by finding the boundary condition of the free end of the rigid link model from the floor reaction force Ff, and solving the equilibrium equation of the weight W1 and inertia of the distal link I. The joint reaction force Fj2 of the base end of the proximal link II can be obtained by solving the equilibrium equation of the weight W2 and inertia of the proximal link II using the joint reaction force Fj1 of the distal link I as the boundary condition for the free end of the proximal link II. This may be repeated by the number of the links.

The joint torques can be obtained from the thus obtained joint reaction forces Fj1 and Fj2. From the torque equilibrium equation of the joint reactions forces at the base end and free end around the gravitational center of the link, the joint torque of the base end can be obtained. From this joint torque, and the joint reaction forces of the free end and base end of the next proximal link, the next proximal joint torque is obtained. This may be repeated by the number of the links.

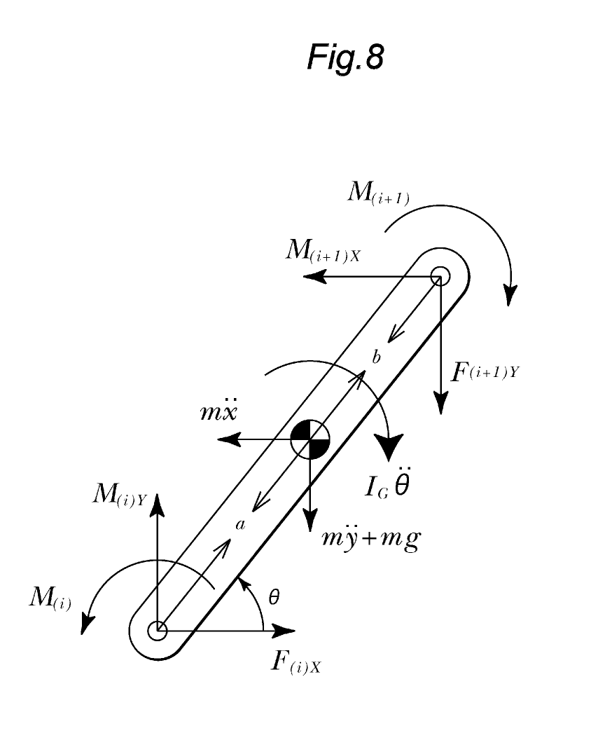

FIG. 8 shows the forces acting upon the i-th link (rigid body) counted from the most distal link in motion. As the force (F₍ᵢ₊₁₎ₓ, F_{(i+1)y}) and torque (M₍ᵢ₊₁₎) acting upon a base end of each link may be considered as a reaction of the force (F₍ᵢ₎ₓ, F_{(i)y}) and torque (M₍ᵢ₎) acting upon the free end of the next proximal link which is connected to the former via a joint, the two forces, as well as the two torques, are opposite in sign. From this diagram, the equilibrium equations can be given as following:

F₍ᵢ₎ₓ−F₍ᵢ₊₁₎ₓ−m₍ᵢ₎(d²x₍ᵢ₎/dt²)₍ᵢ₎=0 (1)

F_{(i)y}−F_{(i+1)y}−m₍ᵢ₎(d²y₍ᵢ₎/dt²)₍ᵢ₎−m₍ᵢ₎g=0 (2)

where F₍ᵢ₎ₓ is the force acting upon the free end of the i-th link in the x-direction, F_{(i)y} is the force acting upon the free end of the i-th link in the y-direction, m₍ᵢ₎ is the mass of the i-th link, g is the gravitational acceleration, x₍ᵢ₎ is the x-coordinate of the gravitational center of the i-th link, and y₍ᵢ₎ is the y-coordinate of the gravitational center of the i-th link.

Equations (1) and (2) can be rewritten as given in the following equations (3) and (4).

F₍ᵢ₊₁₎ₓ=F₍ᵢ₎ₓ−m₍ᵢ₎(d²x₍ᵢ₎/dt²)₍ᵢ₎ (3)

F_{(i+1)y}=F_{(i)y}−m₍ᵢ₎(d²y₍ᵢ₎/dt²)₍ᵢ₎−m₍ᵢ₎g (4)

By substituting the force acting on the lower end (foot) of the most distal link into equations (3) and (4) as the floor reaction force, the reaction forces of all the joints can be obtained one after another from the lower one to the upper one. However, the reaction force obtained here does not account for all of the forces acting upon the joints which are additionally subjected to muscle tensions.

By using the reaction forces at the joint, the joint torque (moment) can be obtained from the torque equilibrium equation as given in the following with reference to FIG. 8.

I_{G}(d²θ/dt²)=M₍ᵢ₎−M₍ᵢ₊₁₎+F₍ᵢ₎ₓa sin θ−F_{(i)y}a cos θ+F₍ᵢ₊₁₎ₓb sin θ−F_{(i+1)y}b cos θ (5)

where I_{G} is the moment of inertia of the i-th link, θ is the angle of the link, M₍ᵢ₎ is the torque acting upon the free end of the i-th link, a is the distance from the gravitational center to the free end, and b is the distance from the gravitational center to the base end.

Equation (5) can be rewritten as given in the following.

M₍ᵢ₊₁₎=M₍ᵢ₎+F₍ᵢ₎ₓa sin θ−F_{(i)y}a cos θ+F₍ᵢ₊₁₎ₓb sin θ−F_{(i+1)y}b cos θ−I_{G}(d²θ/dt²) (6)

Similarly as the reaction force at each joint, the torque acting upon the lower end of the most distal link from the floor reaction is computed, and substituted into Equation (6). The joint torque of all the joints can be obtained one after another from the lower one to the upper one by repeatedly using Equation (6).

In the loading work assisting device 100 of the illustrated embodiment, as the second joint mechanisms L2 and R2 are located ahead of the knee joints of the worker wearing the loading work assisting device 100, and are bent by a certain angle even when the worker is standing upright as shown in FIG. 4, the bending angle of each first joint mechanism L1, R1 does not generally agree with the bending angle of the corresponding hip joint of the worker, and the bending angle of each second joint mechanism L2, R2 does not agree with the bending angle of the corresponding knee joint of the worker, and the bending angle of each third joint mechanism L3, R3 does not agree with the bending angle of the corresponding ankle joint of the worker although there is certain correlation in each case.

Therefore, the bending angle θ used for the computation of each joint torque may be corrected by using a formula which represents the relationship between the bending angle of the corresponding joint mechanism of the loading work assisting device 100 and the actual bending angle of the corresponding joint of the worker.

Therefore, the bending angle θ used for the computation of each joint torque may be corrected by using a formula which represents the relationship between the bending angle of the corresponding joint mechanism of the loading work assisting device 100 and the actual bending angle of the corresponding joint of the worker.

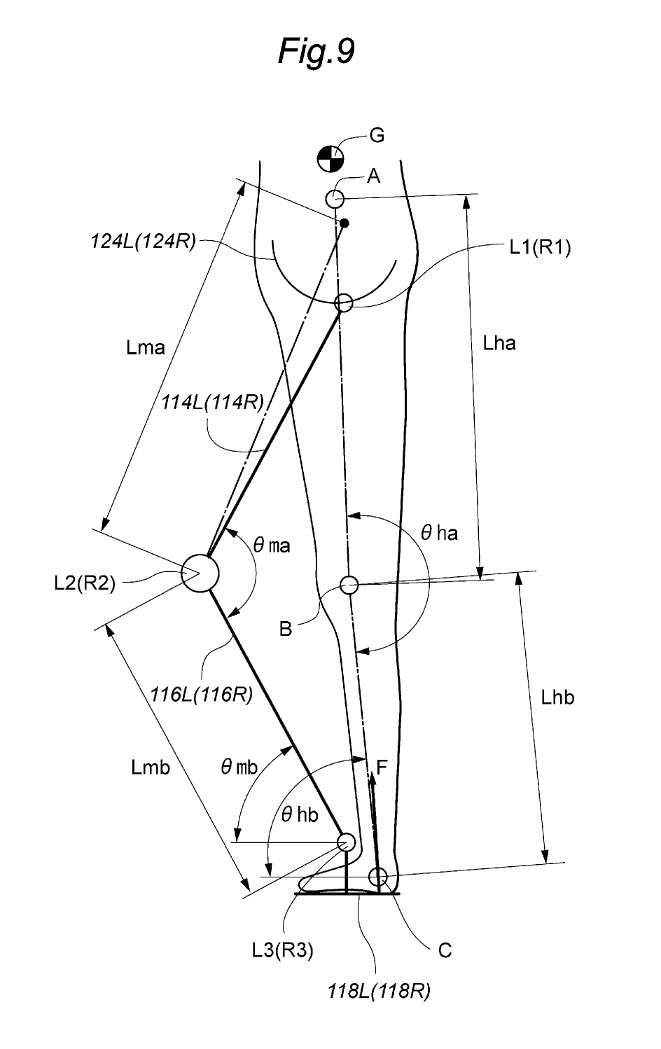

FIG. 9 shows the geometrical relationship between the loading work assisting device 100 and the worker wearing this device. In FIG. 9, Mc denotes the imaginary center of the corresponding arcuate guide bar 124L, 124R. In the following computations, the distance Lma (femoral link length) between the imaginary center Mc and the second joint mechanism L2, R2 and the distance Lmb (crural link length) between the imaginary center Mc and the second joint mechanism L2, R2 are converted into the length Lha of the femoral part between the hip joint A and knee joint B and the length Lhb of the crural part between the knee joint B and ankle joint C, respectively.

The bending angle θma at the second joint mechanism L2, R2 and the bending angle θmb at the third joint mechanism L3, R3 are converted into the actual bending angle θha of the knee joint and the actual bending angle θhb of the ankle joint, respectively. The floor reaction force F acts from the point of contact between the sole and ground to the gravitational center G of the worker.

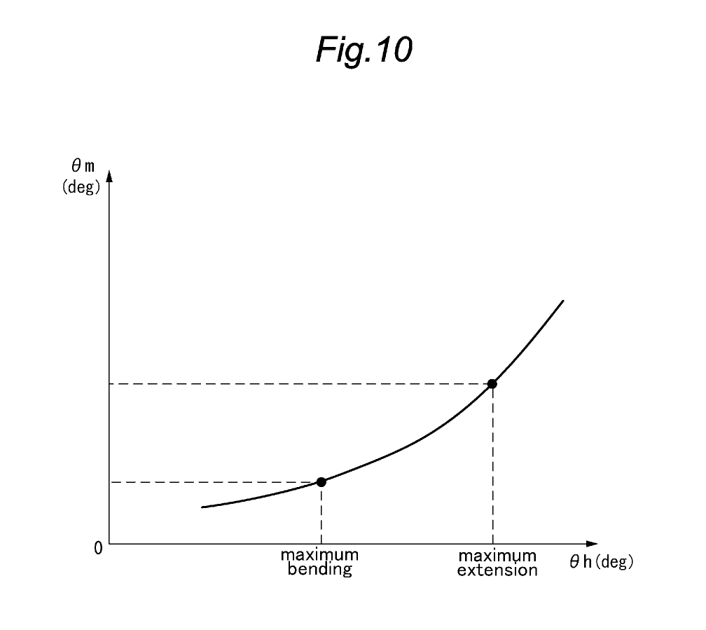

FIG. 10 shows the relationships between the device joint angle θm such as the bending angle θma at the second joint mechanism L2, R2 and the bending angle θmb at the third joint mechanism L3, R3 with the worker's joint angle θh such as the actual bending angle θha of the knee joint and the actual bending angle θhb of the ankle joint. The conversion from the device joint angle θm to the worker's joint angle θh may be made by using the following conversion formula.

θh=αθm²+βθm+γ (7)

where α, β and γ are constants.

The energy consumption of the two legs of the worker wearing the walking assistance device is estimated from the computed joint torques (estimated values of the joint moments. The energy consumption Eh can be computed from the following formula.

Eh=∫Tjωdt (8)

where Tj is the joint torque and ω is the angular speed of joint bending.

The angular speed ω may be obtained by differentiating the angle measured by the corresponding rotary encoder 154L, 154R. The integration of the joint torque Tj is performed with respect to a prescribed time period, and corresponds to the amount of work (or workload) for a given time period.

When the workload smoothing support unit 200 is able to communicate with each of the work assisting devices (such as the walking assistance devices 10 and loading work assistance devices 100) via a wireless link, the system is enabled to acquire information from the work assisting devices in operation so that the workload of each worker engaged in any particular work can be converted into numerical values and the changes in the workload can be monitored on a real time basis.

In this case, the acquired information on the distribution of workload among the workers in the particular work place and the positions of the workers may be visually displayed on the monitor 207.

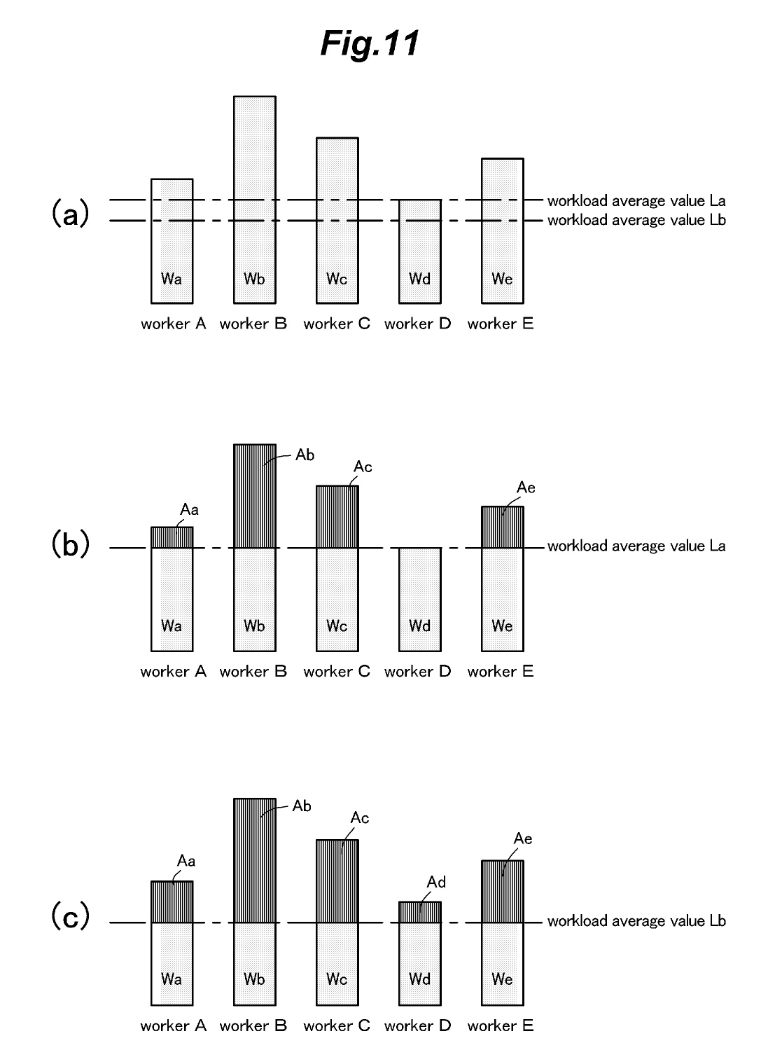

FIG. 11(a) is a bar chart showing the workload values of workers A to E of a group on an assembly line. The workload values indicated by Wa to We in FIG. 11(a) are the workload values when the workers are not wearing any work assistance device. The workload values vary depending on the ability, competence and condition of each worker, and the contents of the work.

The workload standard value determining unit 202 performs the step of determining a prescribed workload standard value. The workload standard value determined by the workload standard value determining unit 202 may consist of a prescribed workload value which is considered to be desirable for the workers, a value (La) equal to the minimum value (Wd) of the workload determined by the worker load numerical processing unit 201, or a value (Lb) equal to a product of a prescribed ratio such as 80% and the minimum value (Wd) of the workload.

The workload deviation computing unit 203 computes the deviation of the workload value (Wa to We) of each worker from the workload standard value (La, Lb) determined by the workload standard value determining unit 202.

The work assistance device allocation unit 204 determines if a work assistance device should be allocated to each worker A to E depending on the workload deviation computed for each worker by the workload deviation computing unit 203. A work assistance device is allocated to those workers whose workload deviations are positive or whose workload values are greater than the workload standard value.

When the workload standard value is given by La, a work assistance device is allocated to the workers A, B, C and E and not to the worker D. On the other hand, when the workload standard value is given by Lb, a work assistance device is allocated to all of the workers A to E.

The work assistance device selection unit 205 is useful when a plurality of kinds of work assistance devices are prepared, and selects an optimum work assistance device for each worker according to the nature of the worker's workload.

For instance, when the work involves the lifting of cargos and components, requiring the squatting movement of the worker, the loading work assistance device 100 which is effective in assisting a squatting movement is selected. If the work more or less exclusively consists of walking, the walking assistance device 10 which is effective in assisting the walking movement of the worker is selected.

The work assistance quantity determining unit 206 determines the amount of work assistance that is required to be produced from the work assistance device (the walking assistance device 10 or the loading work assistance device 100) which is allocated to the worker. The work assistance quantity determining unit 206 determines the amount of work assistance depending on how greater the work assistance quantity Wa to We of each worker is as compared with the workload standard value (La, Lb), preferably such that the workload deviation is reduced to zero or a value close to zero with the aid of the work assistance devices.

The output of each work assistance device (the walking assistance device 10 or the loading work assistance device 100) determined by the work assistance quantity determining unit 206 is either manually or automatically by using the workload smoothing support unit 200.

In a factory or the like where wireless LAN is available for the workload smoothing support unit 200 to make a wireless communication with the work assistance devices (the walking assistance devices 10 and the loading work assistance devices 100), the output of each work assistance device (the walking assistance device 10 or the loading work assistance device 100) may be determined via a wireless communication between the workload smoothing support unit 200 and the work assistance device.

By thus allocating work assistance devices (the walking assistance devices 10 and the loading work assistance devices 100) to the workers, and providing work support to the workers by appropriately selected quantities, the workload values Wa to We for the workers A to E allocated with the work support devices are made even or uniform around the workload standard value (La, Lb) by receiving the corresponding workload assistance quantities Aa to Ae as shown in FIGS. 11(b) and 11(c).

As discussed above, according to the method for smoothing the workload of workers, the workload of each worker A to E is evaluated by a numerical value (quantity), and a work assistance device is selectively allocated to the worker depending on the worker workload value Wa to We in relation with the workload standard value.

Thus, the worker who is under a relatively heavy workload, and causing a bottleneck is supported by the work assistance device that reduces the effective workload of the worker. Thereby, the workload of all the workers in the given work place is made even, and this improves the productivity, saves the need for manpower, and allows the time requirements of different work stations to be made even or optimized.

By determining the work assistance quantity provided by each work assistance device so that the workload deviation is reduced to a value close to zero, the output of each work assistance device (the walking assistance device 10 or the loading work assistance device 100) is optimized, and this contributes to the reduction in CO₂ emission.

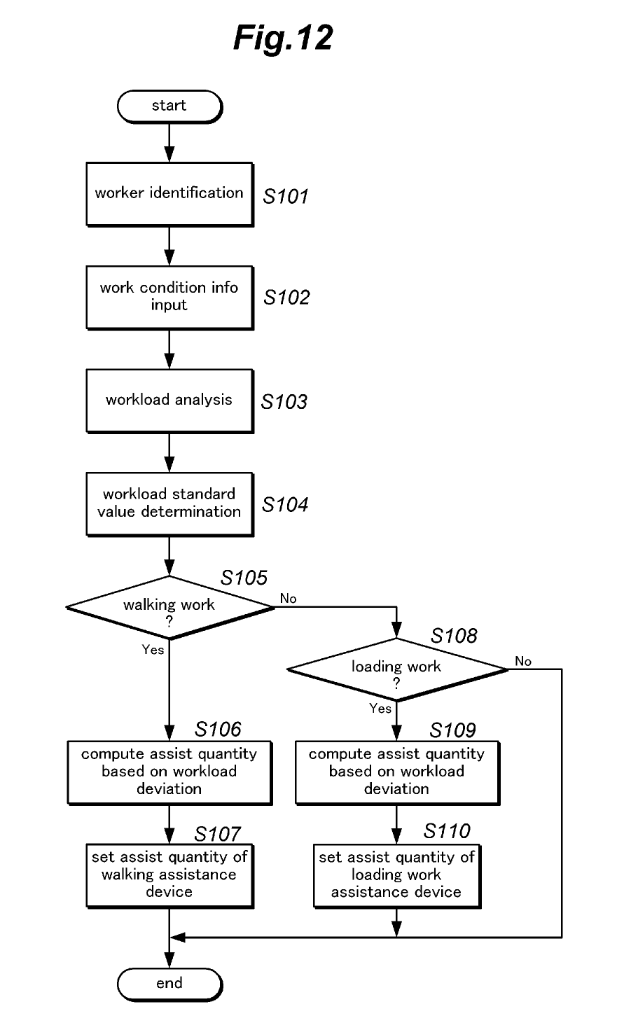

The program flow of the workload smoothing support unit 200 is described in the following with reference to the flowchart of FIG. 12.

First of all, the information on the worker identification number or other information that identifies each worker, and the work contents and work steps is acquired, and each worker is identified (step S101).

Then, the work condition information such as the number of steps, step width, walking speed and floor reaction force, and the physiological information such as the heart rate, myoelectric potential and perspiration is entered (step S102).

By using the worker load numerical processing unit 201, the workload is quantitatively analyzed according to the worker identification information, work condition information and worker's physiological information, and a numerical value representing the workload is obtained (step S103).

The workload standard value is determined by using the workload standard value determining unit 202 (step S104). The workload standard value may consist of a prescribed workload value which is considered to be desirable for the workers, a value (La) equal to the minimum value (Wd) of the workload determined by the worker load numerical processing unit 201, or a value (Lb) equal to a product of a prescribed ratio such as 80% and the minimum value (Wd) of the workload.

The need for allocating a work assistance device to each worker is determined by using the work assistance device allocation unit 204, and the optimum work assistance device is selected from a plurality of kinds of work assistance devices that are made available by using the work assistance device selection unit 205. First of all, it is determined if the work in question primarily consists of walking work. If the work in question is performed primarily by the worker walking and moving, it is decided that a walking assistance device 10 should be allocated to the particular worker (step S105).

The deviation of the workload value from the workload standard value is computed by using the workload deviation computing unit 203. The amount of assistance for the walking assistance device 10 is then determined according to the computed workload value deviation by using the work assistance quantity determining unit 206 (step S106), and the determined amount of assistance is set for the walking assistance device 10 allocated to the worker (step S107).

On the other hand, if the worker's work does not primarily consist of walking, it is determined if the work basically consists of loading work. If it is the case, it is decided that the loading work assistance device 100 should be allocated to the worker (step S108).

The determination of walking work and loading work in steps S105 and 108 may be made from the worker's identification information and the associated information on the nature of the work allocated to the worker and the work assistance device allocated to the worker. It is also possible to determine that the work being performed is loading work if the computed energy consumption is greater than a certain threshold value. Because loading work normally involves little walking, it may be possible to determine the work being performed is walking work if the walking distance and/or walking speed (averaged) are greater than certain threshold values.

The deviation of the workload value from the workload standard value is computed by using the workload deviation computing unit 203. The amount of assistance for the loading work assistance device 100 is then determined according to the computed workload value deviation by using the work assistance quantity determining unit 206 (step S109), and the determined amount of assistance is set for the loading work assistance device 100 allocated to the worker (step S110).

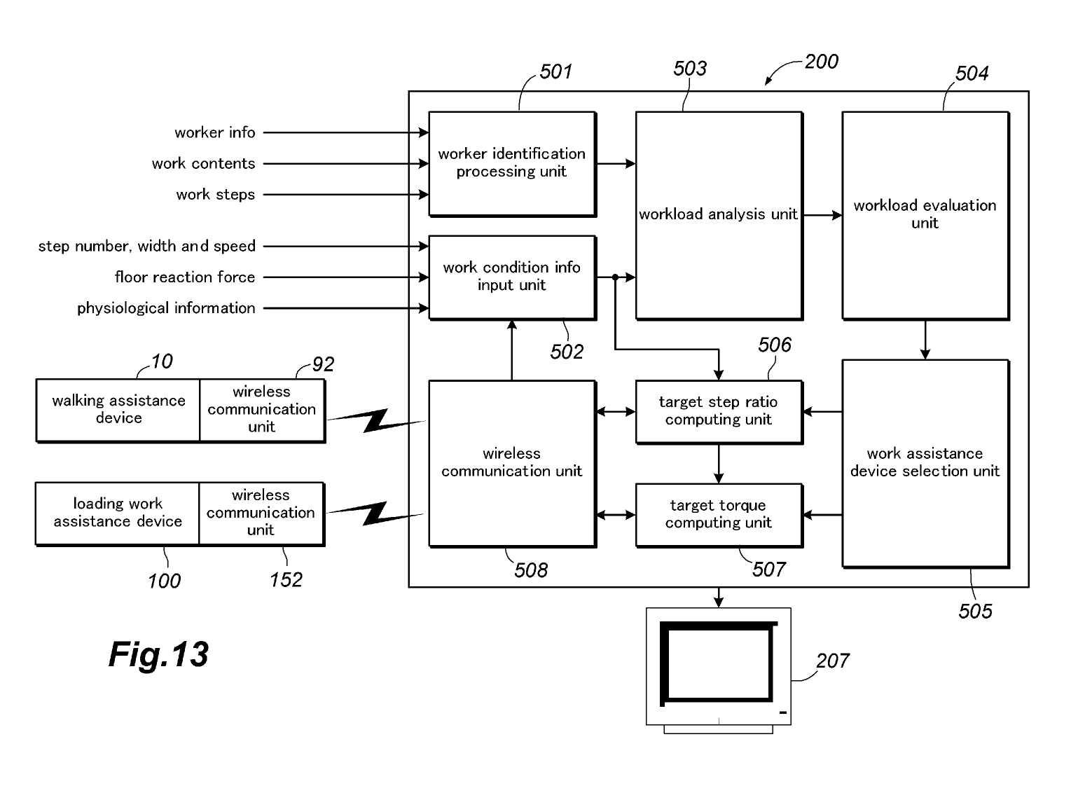

Another embodiment of the workload smoothing support unit 200 is described in the following with reference to FIG. 13. The workload smoothing support unit 200 in this embodiment consists of a computer operating under a program, and comprises a worker identification processing unit 501 and a work condition information input processing unit 502 which provide a means for entering information, a workload analysis processing unit 503, a workload evaluation processing unit 504, a work assistance device selection processing unit 505, a target step ratio computation processing unit 506, a target torque computation processing unit 507 and a wireless communication unit 508, and is connected to a monitor 207 serving as an external output device. The wireless communication unit 508 is configured to perform a bi-directional communication with both the walking assistance device 10 and the loading work assistance device 100 according to a prescribed wireless communication protocol.

The worker identification processing unit 501 receives information on each worker (such as the name and personal identification number) and the work contents and steps allocated to each worker via a keyboard, storage medium or communication, and identifies each worker.

The work condition information input processing unit 502 receives work condition information such as the number of steps, step width, walking speed and floor reaction force, and the physiological information such as the heart rate, myoelectric potential and perspiration for each worker.

The workload analysis processing unit 503 quantitatively analyzes the workload according to the information received by the worker identification processing unit 501 and work condition information input processing unit 502.

The workload evaluation processing unit 504 identifies the kind of the workload, and estimates the amount of the workload that is born by each worker according to the quantitative analysis performed by the workload analysis processing unit 503. This process may be called as the evaluation of workload.

The work assistance device selection processing unit 505 selects one of a plurality of work assistance devices consisting of the walking assistance devices 10 and loading work assistance devices 100 that are made available (in the case of the illustrated embodiment) which is considered to be effective in reducing the workload of the particular worker according to the results of the workload evaluation by the workload evaluation processing unit 504 and the assistance device selection information which is prepared in advance.

When a certain worker is engaged in a work primarily performed by walking and involving a relatively heavy workload, the walking assistance device 10 is selected. When a certain worker is engaged in a work primarily consisting of loading work and involving a relatively heavy workload, the loading work assistance device 100 is selected.

The work assistance device selection information is displayed on the monitor 207 in association with the worker information. Therefore, each worker may select the work assistance device displayed on the monitor 207, and may wear it.

The target step ratio computation processing unit 506 determines the control target step ratio of the walking assistance device 10, and computes the control target step ratio of the walking assistance device 10 according to the information (step number, step width and walking speed) received from the work condition information input processing unit 502.

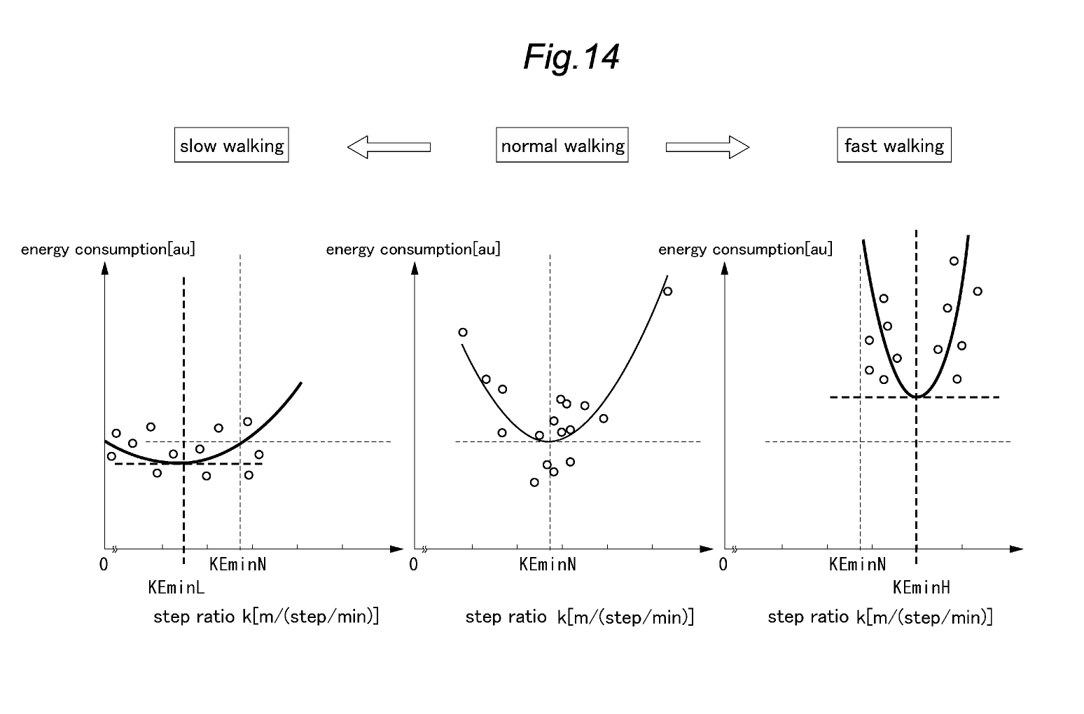

The step ratio is defined as the ratio of the step width (m) to the step number per minute (step/min), and as shown in FIG. 14, there is a particular step ratio KEmin for the given walking speed of the worker that causes a minimum energy consumption (caloric consumption). FIG. 14 shows that the step ratio KEmin that minimizes energy consumption is 0.0075 when the worker walks at the normal speed of 3 km/h, 0.0065 when the worker walks at the slow speed of 1 km/h, and 0.0090 when the worker walks at the fast speed of 5 km/h.

The step ratio versus energy consumption property can be obtained experimentally, and the control target step ratio may be set in dependence on the walking speed so as to minimize the energy consumption at each particular speed. The target step ratio computation processing unit 506 may be incorporated with a data map or the like that produces a step ratio KEminL, KEminN, KEminH for each given walking speed as a control target step ratio.

The walking speed that is used for setting the control target step ratio by using the target step ratio computation processing unit 506 may be a predefined default value for each given set of worker information, work contents and work step. Preferably, the walking speed may be computed from the operating state information of each walking assistance device 10 obtained from the walking assistance device 10 via the wireless communication unit 508 on a real time basis.

The target torque computation processing unit 507 determines the control target torque of the loading work assistance device 100, and computes a control target torque for the given workload of the worker. The control target torque of the loading work assistance device 100 may be a predefined default value for each given set of worker information, work contents and work step. Preferably, the control target torque may be computed from the floor reaction force obtained from each loading work assistance device 100 and the workload of the worker estimated from the physiological information via the wireless communication unit 508 on a real time basis.

The control target step ratio determined by the target step ratio computation processing unit 506, and the target torque determined by the target torque computation processing unit 507 are set to the walking assistance devices 10 and loading work assistance devices 100 in advance.

Preferably, the target step ratio computation processing unit 506 and target torque computation processing unit 507 obtain information on the walking speed, floor reaction force and physiological information from the walking assistance devices 10 and loading work assistance devices 100 via wireless communication on a real time basis, and the optimum control target step ratio and control target torque are computed from the current information so that the computed optimum control target step ratio and control target torque may be transmitted to the walking assistance devices 10 and loading work assistance devices 100 via wireless communication.

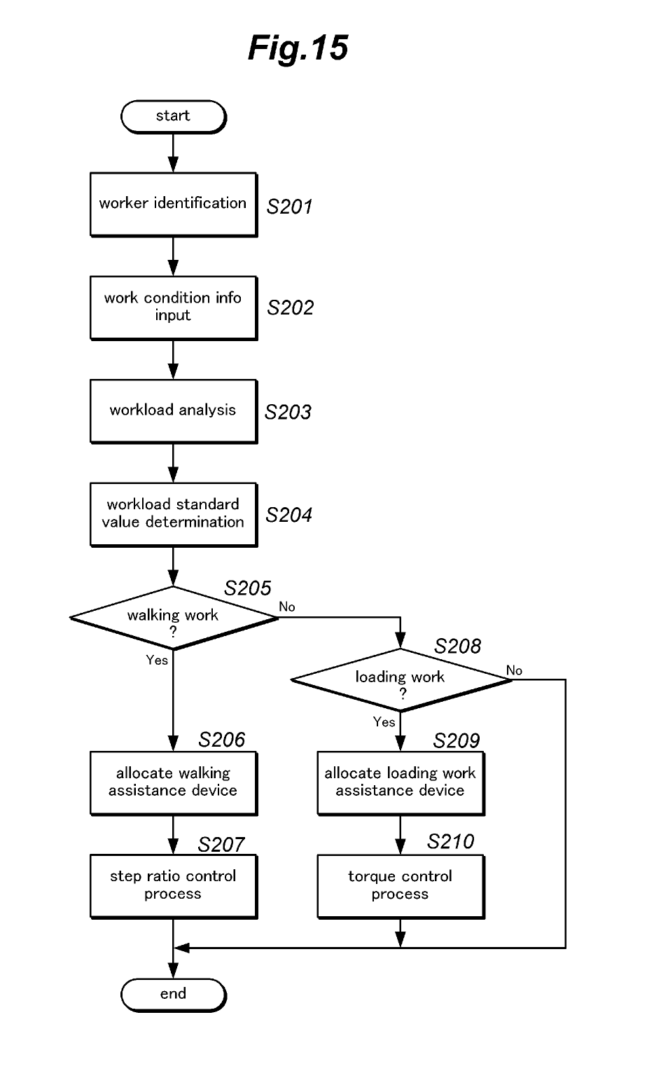

The program flow of the workload smoothing support unit 200 of this embodiment is described in the following with reference to the flowchart of FIG. 15.

First of all, the information on the worker identification number or other information that identifies each worker, and the work contents and work steps is acquired, and each worker is identified by using the work identification processing unit 501 (step S201).

Then, the work condition information such as the number of steps, step width, walking speed and floor reaction force, and the physiological information such as the heart rate, myoelectric potential and perspiration is entered by using the work condition information input processing unit 502 (step S202).

The workload is quantitatively analyzed according to the worker identification information, work condition information and worker's physiological information, and a numerical value representing the workload is obtained by using the workload analysis processing unit 503 (step S203). The total workload value (energy consumption) from the start of the work to the current time point may be computed in step S203.

Based upon the result of the quantitative analysis of the workload, the kind of the workload of the worker is identified, and the workload value born by the worker is estimated by using the workload evaluation processing unit 504 (step S204). For instance, the workload may be evaluated by comparing the total workload value with an appropriate workload value predefined for the worker to bear within a prescribed work time.

It is then determined if the work in question primarily consists of walking work from the evaluation result of the workload evaluation processing unit 504 by using the work assistance device selection processing unit 505 (step S205).

If the work in question is performed primarily by the worker walking and moving, it is decided that a walking assistance device 10 should be allocated to the particular worker (step S206).

When the walking assistance device 10 is selected, the step ratio that causes a minimum energy consumption for the given walking speed obtained by looking up the data map or the like that provides the relationship between the walking speed and step ratio for minimum energy consumption is set as the control target step ratio for the walking assistance device, and the control target step ratio is set to the walking assistance device 10 that is to be allocated (step S207).

In this embodiment, the control target step ratio may be achieved by inputting the hip joint angles into two oscillators (first order and second order), determining the natural angular velocity and controlling the phases of the imaginary oscillators. For the details of this step ratio control process, reference should be made of JP2007-275282A.

On the other hand, if the worker's work does not primarily consist of walking, it is determined if the work basically consists of loading work (step S208). The determination of the walking work and loading work in steps S205 and 208 may be performed similarly as the determination of the walking work and loading work in steps 105 and 108 which are discussed earlier.

If the work basically consists of loading work, it is decided that the loading work assistance device 100 should be allocated to the worker (step S209). The control target torque of the loading work assistance device 100 is determined, and the control target torque is set to the loading work assistance device 100 that is allocated (step S210).

If the work is neither walking work or loading work, neither the walking assistance device 10 or the loading work assistance device 100 is allocated to the worker as it would be wasteful.

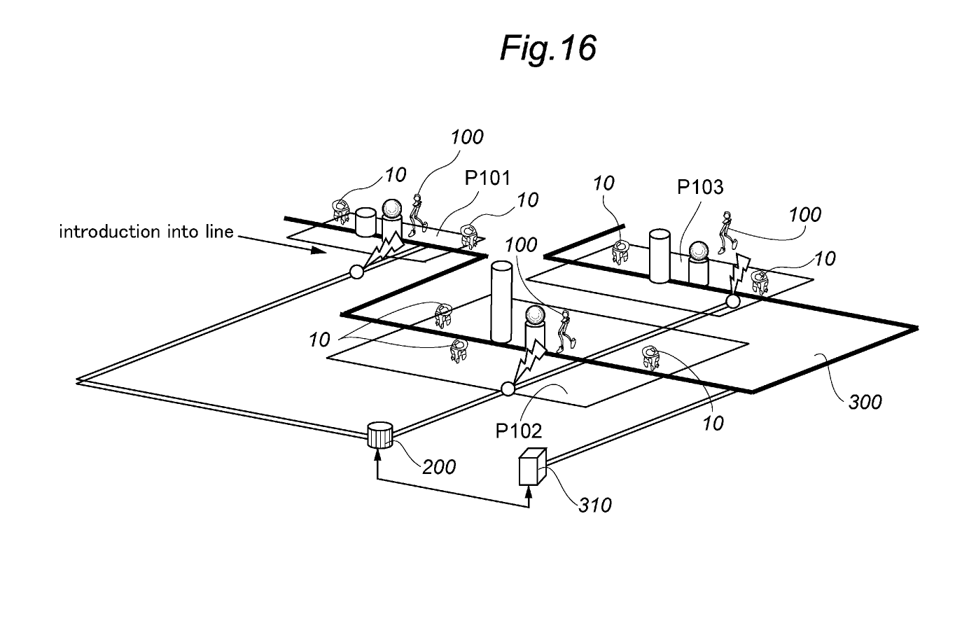

FIG. 16 schematically illustrates an automotive assembly plant to which the method of workload reduction embodying the present invention is applied. The assembly line 300 includes a floor panel assembly station P101, a door panel assembly station P102 and a tire assembly station P103. The line speed of the assembly line 300 is variably controlled by a line speed control device 310.

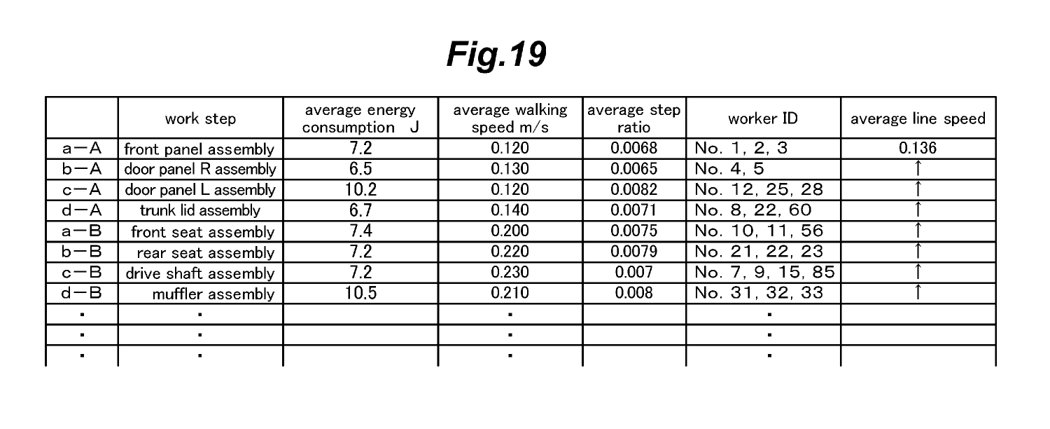

The line speed control device 310 is connected to the workload reduction support processing unit 200 via a data communication link, and is configured to optimally control the line speed according to the actual walking speed and control target step ratio computed by the target step ratio computation processing unit 506 of the workload reduction support processing unit 200. More specifically, when the average energy consumption (average value of the energy consumption of the workers in each area) in any one of the areas shown in FIG. 19 exceeds a prescribed threshold value, the monitor shows a certain color, and reduces the line speed.

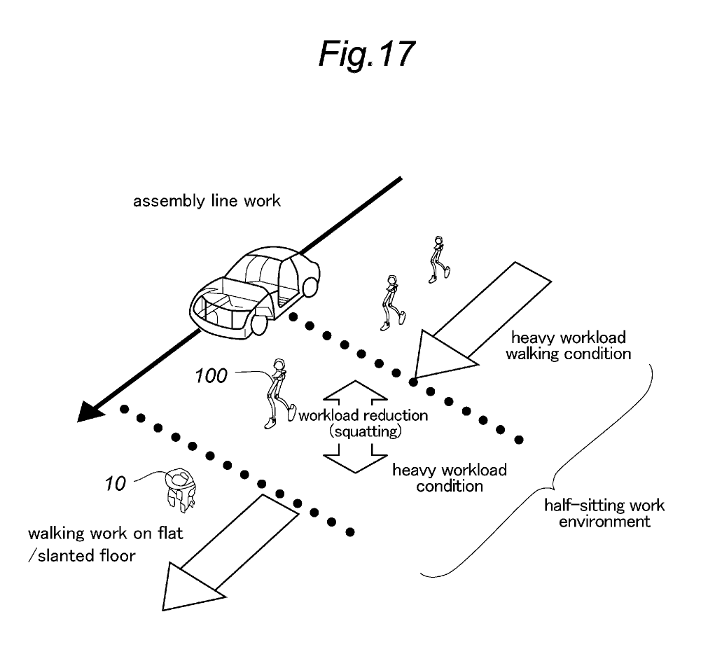

As shown in FIG. 17, in the case of the vehicle body assembly line in which vehicle bases are transported along the assembly line, the workload of the workers engaged in the half-sitting posture work (typically consisting of heavy loading work such as mounting of a propeller shaft and joining a transmission to an engine) involves a relatively large joint moment load, it is necessary to reduce the joint moment of each worker. For this purpose, each worker engaged in the half-sitting posture work is allocated with the loading work assistance device 100.

On the other hand, if the workers are engaged in walking work of a relatively light workload (such as walking work on a horizontal or slightly slanted floor, assembling of light-weight component parts, fastening of screws, pushing carts, and so on), by appropriately inducing a step ratio that can be computed from the step width and step numbers for each unit time, to each particular worker, the energy consumption during the walking work can be minimized. Therefore, each worker engaged in such a light walking work is allocated with a walking assistance device 10.

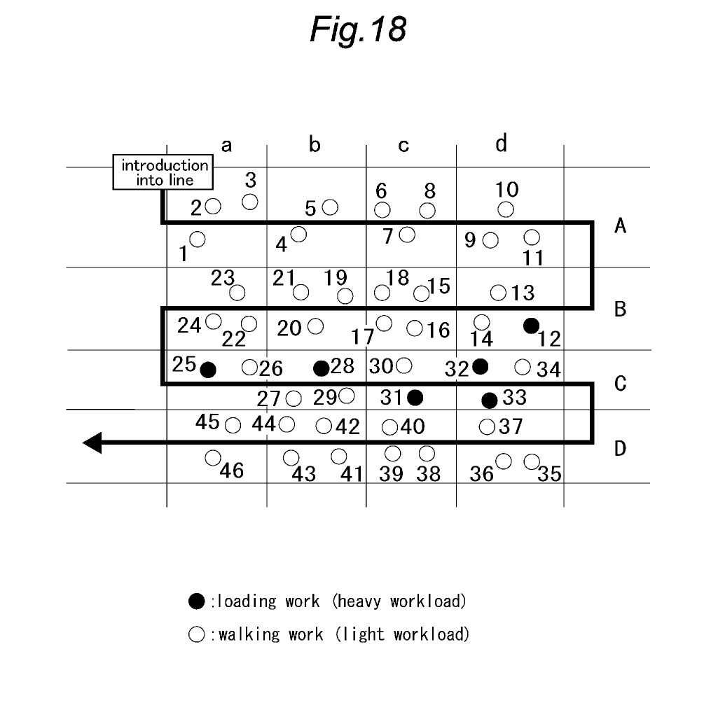

FIG. 18 shows a matrix of work steps that indicates the distribution of workers in each step. The row and column of this matrix are represented by a, b, c and d, and A, B, C and D. White dots indicate the workers engaged in walking work, and black dots indicate the workers engaged in loading work.

As shown in FIG. 19, a table is prepared for each work step that shows the average energy consumption, average walking speed, average step ratio, IDs of the worker engaged in the particular work step, average line speed and overall workload, and is displayed on the monitor 207. Thereby, the working condition of each worker and the operating condition of the assembly line can be quantitatively evaluated.

Thus, the distribution of the workload values of the workers and the positions of the workers in the plant can be visually displayed according to the acquired working condition information.

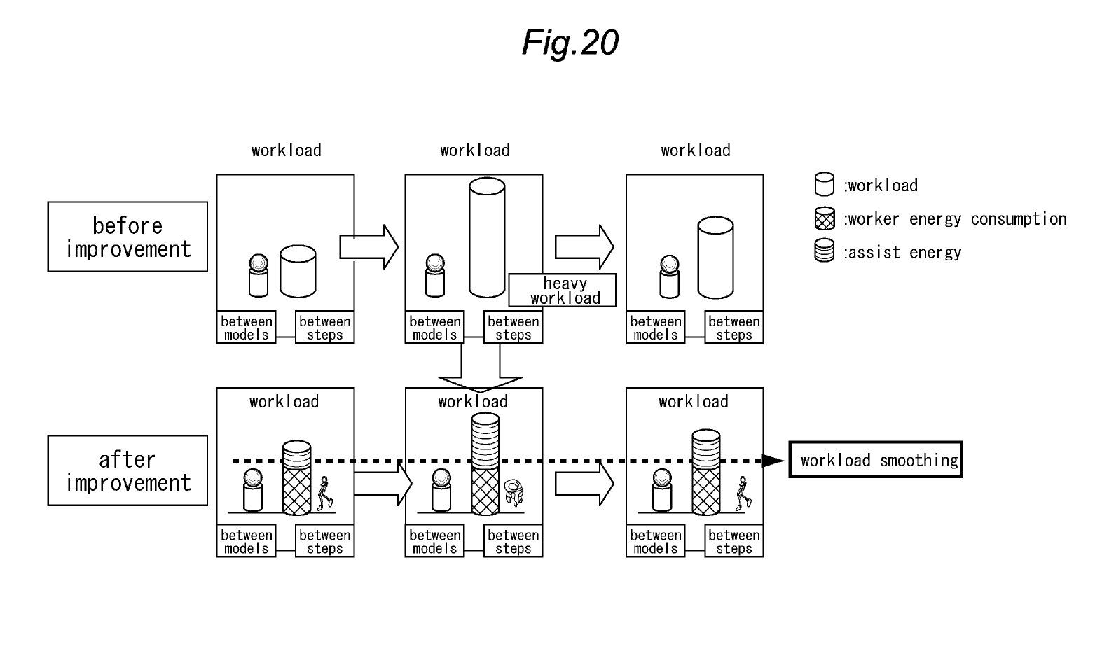

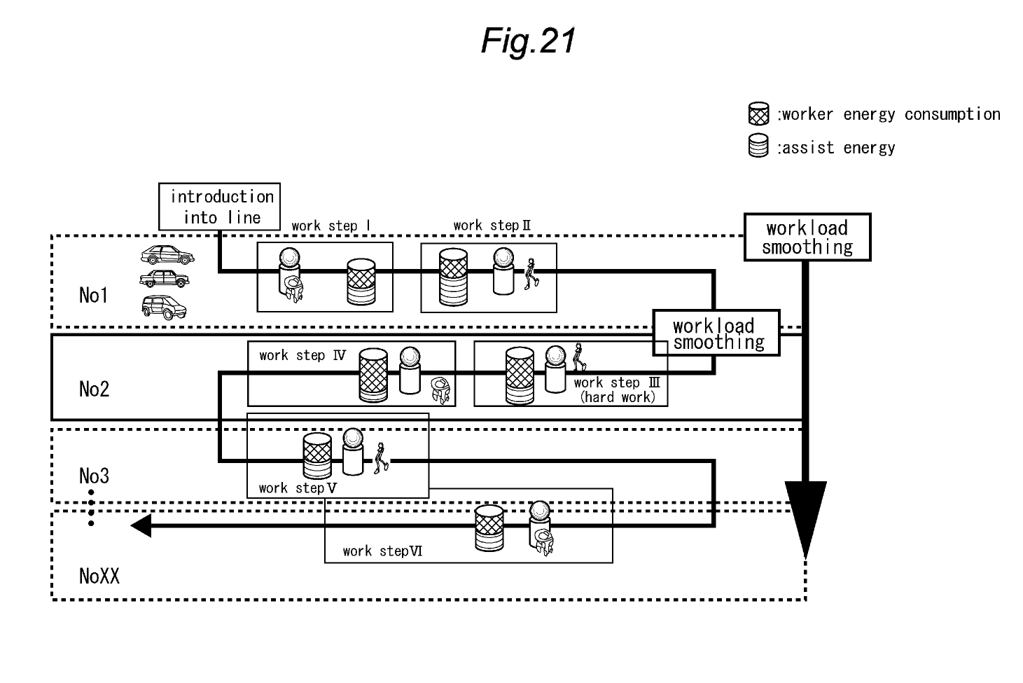

FIG. 20 schematically illustrates the smoothing of the workload between different vehicle models and between different work steps, and FIG. 21 schematically illustrates the smoothing of the workload among the workers in the entire assembly plant. When there are any variations in the workload for each vehicle model on the assembly line or each work step, in order to minimize the variations, the workload values of the workers are selectively reduced by providing certain amounts of work assist to the workers (work energy consumption in the case of the walking assistance device 10 and the joint moment load in the case of the loading work assistance device 100). Thereby, the overall work efficiency of the assembly line can be improved, and the takt time can be reduced.

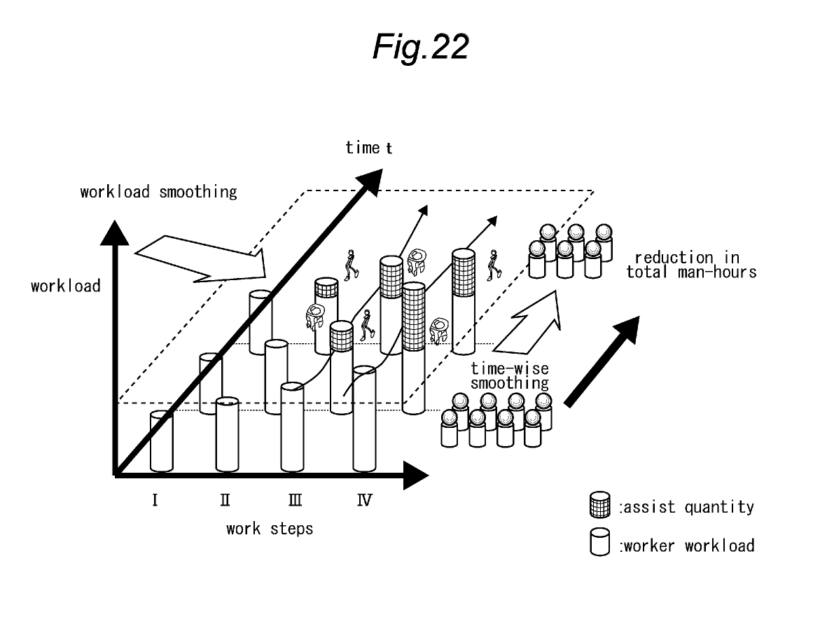

FIG. 22 schematically illustrates the workload condition of a plant to which the method of workload reduction according to the present invention is applied. The amount of assistance and step ratio are varies so as to optimize the smoothing of the workload such that the joint moment load and energy consumption of each worker is reduced. The burden on each worker can be reduced, and the workload can be made even over different work steps and over different time points. Thereby, the necessary manpower may be reduced, the work steps each worker can perform may be increased, and the total amount of work can be reduced. The system of the present invention also allows the takt time to be reduced and the production efficiency to be substantially increased.

### GLOSSARY

10 walking assistance device
100 loading work assistance device
200 workload smoothing support system
201 worker load numerical processing unit
202 workload standard value determining unit
203 workload deviation computing unit
204 work assistance device allocation unit
205 work assistance device selection unit
206 work assistance quantity determining unit

1. A method for smoothing workload by using an information processing system in a work place where a plurality of workers jointly perform work, comprising the steps of:
numerically representing workload of each worker according to information correlated with the workload of the worker;
determining a prescribed standard workload value;
computing a workload deviation of each worker from the standard workload value determined in the step of determining a prescribed standard workload value; and
allocating a work assistance device to each worker depending on the workload deviation computed in the step of determining a workload deviation.

2. The method for smoothing workload according to claim 1, wherein the step of allocating a work assistance device comprises allocating a work assistance device to a worker whose workload is substantially greater than the standard workload value, and the method further comprises the step of setting an amount of work assistance provided by the work assistance device to a level that brings the workload deviation close to zero.

3. The method for smoothing workload according to claim 1, wherein the information correlated with the workload of the worker includes at least a physiological value of the worker measured by a physiological sensor worn by the worker.

4. The method for smoothing workload according to claim 1, wherein the information correlated with the workload of the worker includes at least an amount of work assistance provided by the work assistance device worn by the worker.

5. The method for smoothing workload according to claim 1, wherein the information correlated with the workload of the worker includes at least a joint moment value estimated from a floor reaction force detected by a floor reaction force sensor worn by the worker.

6. The method for smoothing workload according to claim 1, wherein the work assistance device comprises a walking assistance device that is configured to be worn by the worker to induce the step ratio of the worker to a target step ratio, and the method further comprises the step of setting a step ratio that minimizes energy consumption of the worker at a current walking speed as the target step ratio by referring to a property data defining a correlation between the walking speed and the worker's energy consumption.

7. The method for smoothing workload according to claim 1, further comprising the step of acquiring information on the workload and position of each worker from the work assistance device, and visually displaying a distribution of workload among the workers of the work place on a monitor according to the acquired information on the workload and position of each worker.

8. A support system for smoothing workload in a work place where a plurality of workers jointly perform work, comprising:
a worker load numerical processing unit configured to numerically represent workload of each worker according to information correlated with the workload of the worker;
a workload standard value determining unit configured to determine a prescribed standard workload value;
a workload deviation computing unit configured to compute a workload deviation of each worker from the standard workload value; and
a work assistance device allocation unit configured to allocate a work assistance device to each worker depending on the workload deviation computed by the workload deviation computing unit.

9. The support system for smoothing workload according to claim 8, wherein the work assistance device allocation unit is configured to allocate a work assistance device to a worker whose workload is substantially greater than the standard workload value, and the support system further comprises a work assistance quantity determining unit that sets the amount of work assistance provided by the work assistance device such that the workload deviation is close to zero.

10. The support system for smoothing workload according to claim 8, wherein the work assistance device comprises a walking assistance device that is configured to be worn by the worker to induce the step ratio of the worker to a target step ratio, and the support system further comprises a target step ratio setting unit configured to set a step ratio that minimizes energy consumption of the worker at a current walking speed as the target step ratio by referring to a property data defining a correlation between the walking speed and the worker's energy consumption.
